(19) United States
(12) Patent Application Publication
(10) Pub. No.: US 2011/0068119 A1
(43) Pub. Date: Mar. 24, 2011

(54) Tip-Less Pastry Bag

(76) Inventor: Howard W. Wurster, JR., Brant, NY (US)

(21) Appl. No.: 12/877,006

(22) Filed: Sep. 7, 2010

Related U.S. Application Data
(60) Provisional application No. 61/239,992, filed on Sep. 4, 2009.

(51) Int. Cl. B67D 7/00; B65D 35/00; B65B 63/08

(52) U.S. Cl. 222/1; 222/92; 53/440

(57) ABSTRACT

A dispensing package for fluid products generally comprises a bag having a filling end and a dispensing end. A dispensing orifice is located on the dispensing end, to provide a channel through which a fluid product may be dispensed. The dispensing orifice may further comprise more than one orifice. A removable seal may be provided to cover the dispensing orifice. A fluid product may be contained within the bag, and the fluid product may be frozen.

### CROSS-REFERENCE TO RELATED APPLICATION

This application claims the benefit of priority to U.S. provisional patent application Ser. No. 61/239,992 filed Sep. 4, 2009, now pending, the disclosure of which is incorporated herein by reference.

### Field of the Invention

The invention relates to the field of culinary tools, and more particularly to pastry bags having a dispensing end through which toppings, icings, fillings, or other fluid products are discharged from the pastry bag during food preparation.

### BACKGROUND OF THE INVENTION

Toppings, icings, fillings, and like fluid products are packaged in generally conical pastry bags for application to pastry or other food items through a removable dispensing tip extending through a bottom tip portion of the pastry bag. As a user applies pressure to the pastry bag and its contents, the fluid product in the pastry bag is forced out through the dispensing tip to form a dispensed ribbon. Decorator dispensing tips having a discharge orifice which may be any one of various patterns are well known for providing a decorative appearance to ribbons or dollops of topping.

Previous pastry bags generally comprise a separate, rigid dispensing tip assembly which may or may not be disposable. Such previous bags required multiple components which are separately manufactured and require assembly before the bag may be used. Additional manufacturing and/or assembly steps increase the complexity of the device, thereby increasing the cost. It may not be economical to dispose of such pastry bags after a single use.

Also, a known problem exists where the separate dispensing tip of previous pastry bags may be dislodged from the bag during use. A dislodged dispensing tip may become buried under the topping of a food product and thereby becomes a choking hazard.

### BRIEF SUMMARY OF THE INVENTION

It is therefore an object of the present invention to provide an economical pastry bag dispensing package, having a dispensing orifice on a dispensing end, to allow for dispensing a fluid product without the need for a separate dispensing tip assembly.

It is another object of the present invention to provide a pre-filled, disposable pastry bag dispensing package having a fluid product, which may be frozen, contained within.

It is another object of the present invention to provide a pastry bag having the ability to create decorative patterns with toppings or other fluid products, without a separate component which may become dislodged and create a choking hazard.

In furtherance of these and other objects, a dispensing package for fluid products generally comprises a bag having a filling end and a dispensing end. A dispensing orifice is located on the dispensing end, to provide a channel through which a fluid product may be dispensed. The dispensing orifice may further comprise more than one orifice. A removable seal may be provided to cover the dispensing orifice. A fluid product may be contained within the bag, and the fluid product may be frozen.

### DESCRIPTION OF THE DRAWINGS

For a fuller understanding of the nature and objects of the invention, reference should be made to the following detailed description taken in conjunction with the accompanying drawings, in which:

FIG. 1 is a side view of a dispensing package in accordance with an embodiment of the present invention;

FIG. 2a is a side view of a dispensing package with more than one dispensing orifice in accordance with another embodiment of the present invention;

FIG. 2b is a dispensing end view of the pastry bag of FIG. 2a;

FIG. 3 is a cross-sectional view of the dispensing end portion of a dispensing package in accordance with another embodiment of the present invention;

FIG. 4A depicts a dispensing end view of a dispensing package according to an embodiment of the present invention showing oval orifices;

FIG. 4B depicts a dispensing end view of a dispensing package according to an embodiment of the present invention showing oval orifices;

FIG. 4C depicts a dispensing end view of a dispensing package according to an embodiment of the present invention showing oval orifices; and

FIG. 5 is a flowchart of a method according to an embodiment of the present invention.

### DETAILED DESCRIPTION OF THE INVENTION

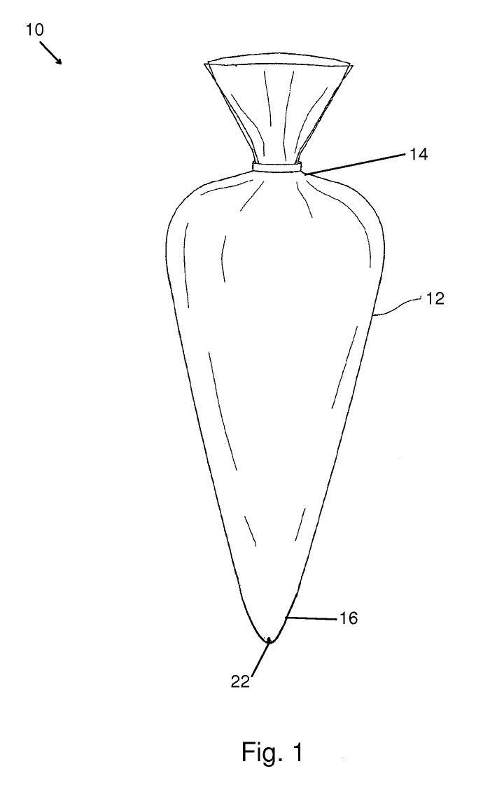

Reference is made initially to FIG. 1, wherein a dispensing package formed in accordance with an embodiment of the present invention is shown and generally identified by reference numeral 10. Dispensing package 10 includes a bag 12 having a filling end 14 through which topping or other fluid product 20 may be introduced into the bag 12 in a filling operation, and a dispensing end 16 through which the fluid product 20 is dispensed by a user. The filling end 14 may be wider than the dispensing end 16. As such, the bag 12 may have a substantially conical shape. At least one dispensing orifice 22 is located on the dispensing end 16, to provide a channel through which the fluid product 20 is dispensed. It will be understood that other bag shapes may be used, and that the location of the dispensing orifice 22 is a matter of design choice depending on the shape of the bag and the particular application for which it is used. As a non-limiting example, the bag may have a generally rectangular shape, and the dispensing orifice may be located at a bottom corner of the bag.

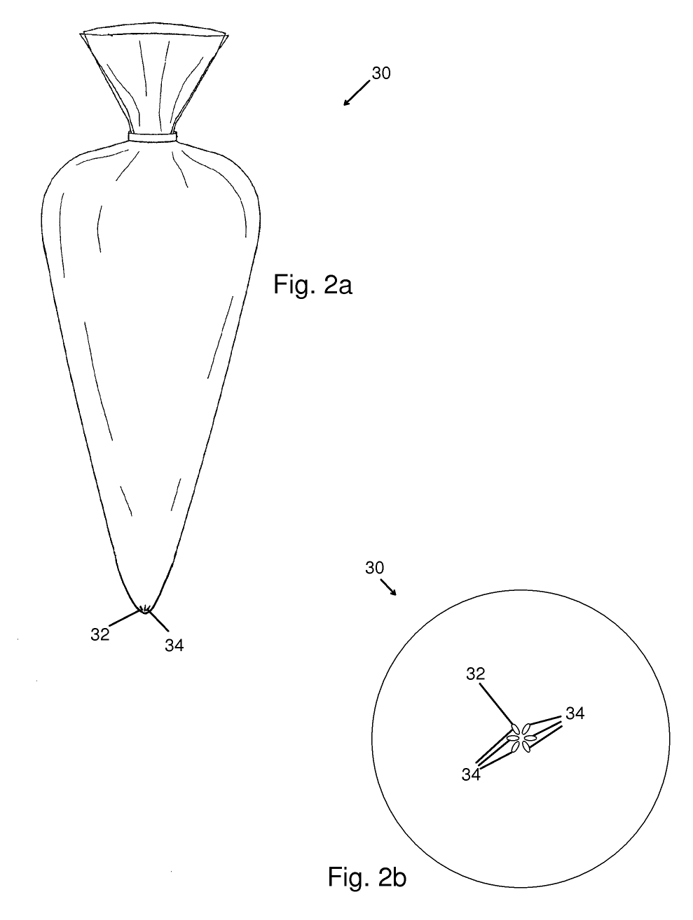

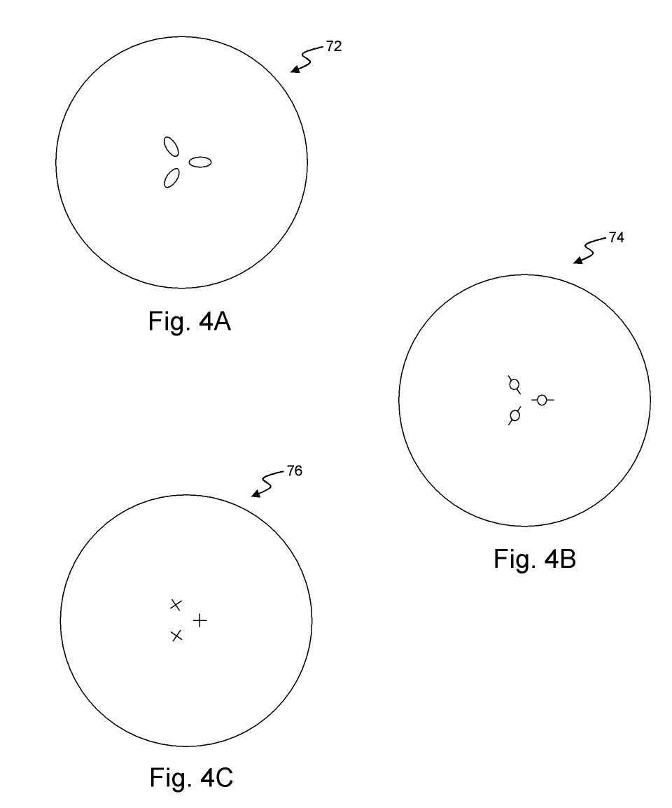

The dispensing orifice 22 may be die-cut into the bag 12. The shape of the dispensing orifice 22 can be any shape, and is a matter of design choice. As such, the dispensing orifice 22 will cause the fluid product 20 to be dispensed with a decorative appearance desired by the user. The shape of the dispensing orifice 22 may be, for example but not limited to, a round shape or a slit shape. The dispensing orifice 22 may comprise more than one orifice to provide additional options to the user. FIGS. 2a and 2b depict an embodiment of a package 30 according to the invention having a dispensing orifice 32 with six orifices 34. In this manner, decorative shapes, such as dollops, may be dispensed by the user. FIGS. 4A-4C depict other exemplary (non-limiting) embodiments of a dispensing orifice having oval shapes 72, slit-circle shapes 74, and slit cross shapes 76.

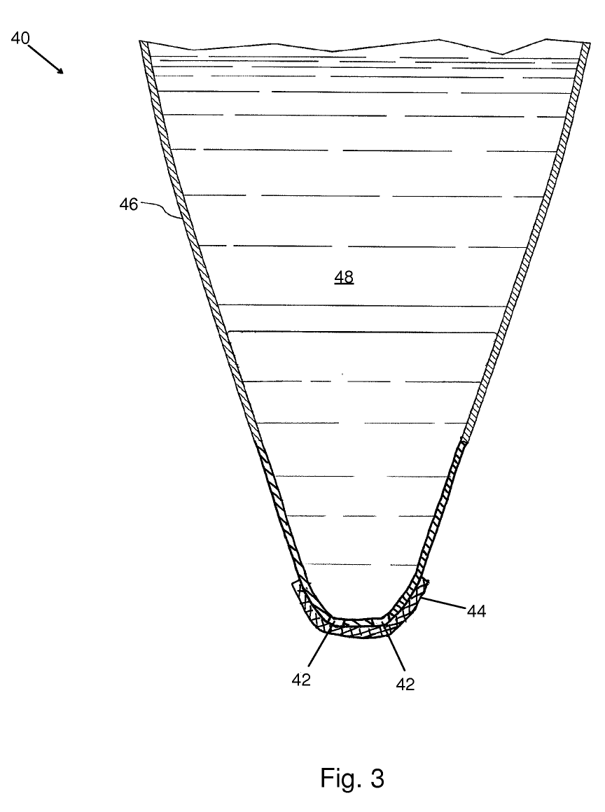

FIG. 3 depicts a cross-section of the dispensing end of a package 40 having two orifices 42. The package 40 further comprises a removable seal 44 covering the orifices 42. The removable seal 44 may be a label or other film seal. The removable seal 44 may be a thin film which is disposed on the bag 46 using an adhesive. The removable seal 44 may be applied to the bag 46 as a liquid which dries or cures to a solid seal. The dispensing package 40 may further comprise a fluid product 48, which may be a topping, contained within the bag 46. In this manner, the dispensing package 40 may be sold as a pre-filled, disposable pastry bag. The fluid product 48 may be frozen.

A package according to embodiments of the present invention is comprised of a bag having a dispensing orifice through which fluid product is dispensed directly onto the desired product (e.g., a cake). A separate tip element is not necessary and not used. In this way, among other advantages, the expense of a tip element is not incurred and safety issues where tip elements may separate from a dispensing bag and be hidden in the discharged fluid product, are eliminated.

The bag of the dispensing package may be constructed from materials, including, but not limited to, plastic sheeting, rubber, latex, and other elastomers. The selected material may resist deformation such as tearing or stretching. As such, the dispensing orifice may resist deforming by tearing or stretching. The bag may be constructed of a reinforced material. For example, the material may comprise reinforcing fibers.

In use, a user may cause a dispensing package, comprising a frozen fluid product, to thaw. Once thawed, the user removes the removable seal from the dispensing portion of the bag, thus exposing the dispensing orifice. The user then applies pressure to the bag to cause the thawed fluid product to discharge through the dispensing orifice. The user may selectively apply pressure to the bag to cause fluid product to flow constantly or intermittently as desired. The fluid product is caused to flow directly from the bag, through the dispensing orifice, to the desired position (e.g., on a cake), without flowing through a separate tip component.

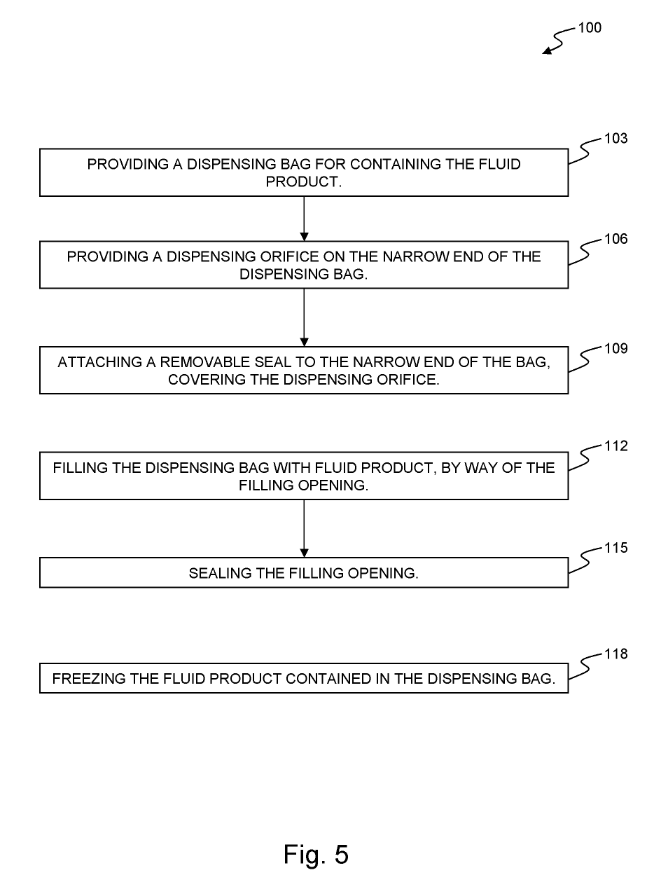

The present invention may be embodied as a method 100 of producing a disposable dispensing package for fluid products (FIG. 5). The method includes providing 103 a dispensing bag for containing the fluid product. The dispensing bag has a narrow end and a wide end, the wide end of the bag has a filling opening. A dispensing orifice is provided 106 on the narrow end of the dispensing bag. Such a dispensing orifice may be formed using a die or a knife to cut the desired opening, or other technique known in the art. A removable seal is attached 109 to the narrow end of the bag. The removable seal covers at least the dispensing orifice.

The method 100 may also include the step of filling 112 the dispensing bag with fluid product using the filling opening. The filling opening may then be sealed 115 such that the fluid product is sealed within the bag (by the sealed filling opening on one portion of the bag, and by the removable seal on another portion of the bag). The fluid product may be frozen 118.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A dispensing package for fluid products, comprising:
a bag for receiving fluid product, the bag having a filling end and a dispensing end;
the dispensing end having a dispensing orifice through which fluid product is discharged from the bag.

2. The dispensing package of claim 1, wherein the dispensing orifice further comprises more than one orifice.

3. The dispensing package of claim 1, further comprising a removable seal covering the dispensing orifice.

4. The dispensing package of claim 3, further comprising fluid product contained within the bag.

5. The dispensing package of claim 4, wherein the fluid product is frozen.

6. The dispensing package of claim 1, wherein the dispensing orifice is a cross shape.

7. The dispensing package of claim 1, wherein the dispensing orifice is an oval shape.

8. The dispensing package of claim 1, wherein the dispensing orifice is a slit circle shape.

9. A method of producing a disposable dispensing package for fluid products, comprising the steps of:
providing a dispensing bag for containing the fluid product, the dispensing bag having a narrow end and a wide end, the wide end of the bag having a filling opening;
providing a dispensing orifice on the narrow end of the dispensing bag; and
attaching a removable seal to the narrow end of the bag, such that the removable seal covers at least the dispensing orifice.

10. The method of claim 9, further comprising the steps of:
filling the dispensing bag with fluid product using the filling opening; and
sealing the filling opening.

11. The method of claim 10, further comprising the step of:
freezing the fluid product contained in the dispensing bag.

12. A method of dispensing a fluid product, comprising the steps of:
providing a dispensing package, the dispensing package comprising:
a bag for receiving fluid product, the bag having a dispensing orifice through which fluid product is discharged from the bag; and
fluid product contained within the bag;
discharging the fluid product from the bag through the dispensing orifice; and
wherein the fluid product is discharged directly from the dispensing orifice without flowing through a tip.

13. The method of claim 12, wherein the fluid product is frozen, and the method further comprising the step of allowing the frozen fluid product to thaw.

14. The method of claim 12, wherein the provided bag further comprises a removable seal, and the method further comprising the step of removing the removable seal.
